(19) United States
(12) Patent Application Publication
(10) Pub. No.: US 2011/0273360 A1
(43) Pub. Date: Nov. 10, 2011

(54) COMBINATION RADIO FREQUENCY IDENTIFICATION AND ELECTRONIC ARTICLE SURVEILLANCE ANTENNA SYSTEM

(75) Inventors: Richard John CAMPERO, San Clemente, CA (US); Bing JIANG, San Diego, CA (US); Steve E. TRIVELPIECE, Irvine, CA (US)

(73) Assignee: SENSORMATIC ELECTRONICS, LLC, Boca Raton, FL (US)

(21) Appl. No.: 13/187,098

(22) Filed: Jul. 20, 2011

Related U.S. Application Data
(63) Continuation-in-part of application No. 12/247,994, filed on Oct. 8, 2008.
Application No. 12/247,994 is a continuation-in-part of application No. 12/480,646, filed on Jun. 8, 2009.
(60) Provisional application No. 61/400,185, filed on Jul. 23, 2010.
(60) Provisional application No. 60/978,389, filed on Oct. 8, 2007.
(60) Provisional application No. 61/059,665, filed on Jun. 6, 2008.

(51) Int. Cl. H01Q 21/30

(52) U.S. Cl. 343/893

(57) ABSTRACT

An RFID antenna for use in an RFID-EAS antenna system is disclosed. In one embodiment, the RFID antenna has a first patch antenna element and a second patch antenna element that are electrically connected and coplanar. The RFID antenna also has a reference ground plane coplanar with the patch antenna elements.

### CROSS-REFERENCE TO RELATED APPLICATION

This application is related to and claims priority to U.S. Provisional Application Ser. No. 61/400,185, filed Jul. 23, 2010, entitled DUAL RFID-EAS ANTENNA PEDESTAL SYSTEM, the entirety of which is incorporated herein by reference. This application is also a continuation in part of, and claims priority to, U.S. application Ser. No. 12/247,994, filed Oct. 8, 2008 for “RFID Patch Antenna with Coplanar Reference Ground and Floating Grounds”, which claims priority to provisional U.S. Patent Application Ser. No. 60/978,389, filed Oct. 8, 2007 for “RFID Patch Antenna with Coplanar Reference Ground and Floating Grounds”, the contents of both of which are incorporated herein by reference in their entirety. This application is also a continuation in part of, and claims priority to, U.S. patent application Ser. No. 12/480,646, filed Jun. 8, 2009 for “Broadband Antenna with Multiple Associated Patches and Coplanar Grounding for RFID”, which claims priority to provisional U.S. Patent Application Ser. No. 61/059,665, filed Jun. 6, 2008, the contents of both of which are also incorporated herein by reference in their entirety.

### STATEMENT REGARDING FEDERALLY SPONSORED RESEARCH OR DEVELOPMENT

n/a

### FIELD OF THE INVENTION

The present invention relates to antennas for a combination radio frequency identification—electronic article surveillance (RFID-EAS) system, and more particularly to a patch antenna and antenna system for use in a combination RFID-EAS system

### BACKGROUND OF THE INVENTION

Electronic Article Surveillance (EAS) is a method for preventing shoplifting from retail stores or other valuable items from their existing locations. Special tags are fixed to items and alarms will be triggered if an active EAS tag is detected. In order to activate an EAS tag, a strong magnetic field is created by using a magnetic loop or other methods. Because of the good penetration characteristics of magnetic waves, EAS systems provide good detection success even when a human body or other blocking materials are present. However, EAS systems usually can only provide on/off status without additional detailed information about the tagged item.

Radio frequency identification (RFID) systems are increasingly used to track items whose locations or dispositions are of importance for economic, safety or other reasons. In RFID applications, typically, transponders or tags are attached to or placed inside the items to be tracked, and these transponders or tags are in at least intermittent communication with transceivers or readers which report the tag (and, by inference, item detail information) to people or software applications via a network to which the readers are directly or indirectly attached.

Examples of RFID applications include tracking of retail items being offered for public sale within a store, inventory management of those items within the store backroom, on store shelving fixtures, displays, counters, cases, cabinets, closets, or other fixtures, and tracking of items to and through the point of sale and store exits. Item tracking applications also exist which involve warehouses, distribution centers, trucks, vans, shipping containers, and other points of storage or conveyance of items as they move through the retail supply chain. Another area of application of RFID technology involves asset tracking in which valuable items (not necessarily for sale to the public) are tracked in an environment to prevent theft, loss, or misplacement, or to maintain the integrity of the chain of custody of the asset. These applications of RFID technology are given by way of example only, and it should be understood that many other applications of the technology exist.

RFID systems typically use reader antennas to emit electromagnetic carrier waves encoded with digital signals to an RFID tag. As such, the reader antenna facilitates communications between a tag and the reader, and influences the quality of that communication. A reader antenna converts signal-bearing alternating electrical current from the reader into signal-bearing oscillating electromagnetic fields or waves appropriate for an adjacent second antenna located in the tag. The reader also facilitates the reverse process of converting signal-bearing oscillating electromagnetic fields or waves (sent from or modified by the tag) into signal-bearing alternating electric current for demodulation by the reader.

Generally speaking, the resonance characteristics and tuning (and tunability) of the reader antenna is determined not only by the antenna geometric shape and dimensions, stack-up (material layering) and construction, and fabrication materials, but also by the characteristics of the environment surrounding the antenna. Ideally, an RFID antenna will have large bandwidth that will effectively emit and receive signals in a relatively wide frequency range centered on or near the frequency at which the RFID tags and reader are designed to operate. For antennas of sufficient bandwidth, small changes in system resonance characteristics caused by occasional and largely uncontrollable changes in the antenna surroundings will not cause a fatal detuning of the antenna away from the design frequency. Types of antennas used in RFID systems include patch antennas, slot antennas, dipole antennas, loop antennas, and many other types and variations of these types.

In the case of passive RFID systems, the RFID tag is powered by the electromagnetic carrier wave. Once powered, the passive tag interprets the radio frequency (RF) signals and provides an appropriate response, usually by creating a timed, intermittent disturbance in the electromagnetic carrier wave. These disturbances, which encode the tag response, are sensed by the reader through the reader's antenna. In the case of active RFID systems the tag contains its own power source, such as a battery, which it can use to either initiate RF communications with the reader by creating its own carrier wave and encoded RF signals, or to enhance the tag performance by increasing the tag's data processing capability or by increasing the power in the tag's response, and hence maximizing the distance of communication between the tag and reader.

The detection range of passive RFID systems is typically limited by signal strength over short ranges, for example, frequently less than 10 meters for existing passive UHF RFID systems. Due to this read range limitation in passive UHF RFID systems, a large fixed reader antenna driven with sufficient power to detect tagged items within a pre-specified space may be used. However, such an antenna may be unwieldy, aesthetically displeasing, and the radiated power may surpass allowable legal or regulatory limits. Furthermore, these reader antennas are often located in stores or other locations were space is at a premium and it is expensive and inconvenient to use such large reader antennas. As an alternative, beam-forming smart antennas can scan the space with a narrow beam and without moving parts. However, as active devices they are usually big and expensive if compared with passive antennas.

To overcome the disadvantages of the approaches described above, fixed arrays of antennas are utilized in some UHF RFID applications. In this approach several reader antennas spanning over a large area are connected to a single reader or group of readers via some sort of switching network, as described for example in U.S. Pat. No. 7,084,769. Pedestal, smart shelving, and other similar applications involving the tracking or inventory auditing of tagged items in or on RFID-enabled wall, shelves, cabinets, cases, racks, or other fixtures can make use of fixed arrays of small antennas.

In tracking tagged items in pedestal and similar applications, the pre-specified space for monitoring is usually a narrow space spanning from the ground to the human height. Such a radiation pattern is difficult to reach for a single large fixed antenna, even for a beam-forming antenna. Fixed arrays of small antennas offer several advantages. First, the pre-specified space for monitoring can be divided into a smaller space for each antenna, and thus it requires relatively less power to survey the space surrounding each antenna. Thus, in systems which query these antennas one at a time, the system itself requires relatively little power (usually much less than 1 watt). As a result, the system reduces the false alarm for tags from the unintended area. The smaller space also loosens the requirements of the radiation pattern for each antenna, i.e., the manufacturing cost for the antenna will be low.

In pedestal the antennas used in the antenna array should be simple, low cost, easy to retrofit into an existing infrastructure, easy to hide from the view of people in the vicinity of the antennas, and that the antennas can be installed and connected quickly. These application requirements are more easily met with an antenna configuration which minimizes the overall antenna thickness. That is, thin or low profile antennas are easier to hide, and easier to fit into existing infrastructure without requiring special modification to that existing infrastructure. Also, reducing the antenna thickness tends to reduce antenna cost, since less material is used in a thinner antenna.

For reasons of cost and installation convenience it is also desirable to have the simplest possible approach to the attachment of the RF feed cables or wires to the antennas. Preferably, the attachment should be made in one location, on one surface, without requiring a hole or special channel, wire, or conductive via through the antenna substrate.

The design of the UHF antennas should allow for reading of RFID tags in the space near the antennas without “dead zones” or small areas between and around antennas in which the emitted fields are too weak to facilitate communication between the tag and reader. It is also desired that the antennas used in pedestal and similar applications have the ability to read items with a diversity of tag antenna orientations (i.e., tag orientation independence, or behavior at least approaching that ideal).

Traditional patch antennas, slot antennas, dipole antennas, and other common UHF antenna types which might be used in antenna systems such as those described above generally involve multiple layers. U.S. Pat. No. 6,639,556 shows a patch antenna design with this layered structure and a central hole for the RF feed. U.S. Pat. No. 6,480,170 also shows a patch antenna with reference ground and radiating element on opposing sides of an intervening dielectric. A multi-layer antenna design can lead to excessive fabrication cost and excessive antenna thickness (complicating the retrofitting of existing infrastructure during antenna installation, and making it more difficult to hide the antennas from view). Multi-layer antenna designs also tend to complicate the form of the attachment of the connecting wires (for example, co-axial cable between the antenna and reader) since the connection of the signal carrier and reference ground occurs on different layers.

Typical UHF pedestal applications use a patch antenna because the fields emitted from the patch antenna are predominantly in the direction orthogonal to the plane of the antenna, so the antenna can be placed on or inside the shelf surface and create an RFID-active space in the region immediately in front of the pedestal. Of course, this presupposes that the particular patch antenna design yields sufficient bandwidth, circular polarization bandwidth, and high gain to create, for a given convenient and practical power input, a defined space around the antenna wherein tagged items can be dependably and consistently read.

A traditional patch antenna described in the prior art is shown in FIG. 1. The patch antenna 10 of FIG. 1 has a main radiating element 14 of conductive material fabricated on top of a dielectric material 12. The main radiating element 14 may be fed through a via 18. Beneath (i.e., on the reverse side of) the dielectric material is typically located a reference ground element 16, which is a planar layer of conductive material electrically grounded with respect to the signals being transmitted or received by the antenna.

In the typical patch antenna design, the antenna main radiating element and the reference ground element are in parallel planes separated by the dielectric material (which, in some cases, is simply an air spacer). Also, in the usual case, the main radiating element and the reference ground element are fabricated with one directly above the other, or with one substantially overlapping with the other in their respective parallel planes. A disadvantage of this traditional multi-layer patch antenna design is that the connection of the shielded cable or twisted pair wire carrying signals between the antenna and the RFID reader must be attached to the antenna on two separate levels separated by the dielectric material, thus requiring a connecting hole or via in the dielectric layer.

The size of the gap between the radiating element and the reference ground conductor (i.e., the dielectric layer thickness) is a critical design parameter in the traditional patch antenna since, for a given dielectric material, the thickness of this gap largely determines the bandwidth of the antenna. As the gap is reduced, the bandwidth is narrowed. If the bandwidth of the antenna is too narrow, the tuning of the antenna in a given application becomes very difficult, and uncontrollable changes in the environment during normal operation (such as the unanticipated and random introduction of metal objects, human hands, or other items or materials into the area being monitored by the antenna) can cause a shift in resonance frequency which, combined with the overly narrow bandwidth, causes a significant detuning of the antenna and failure in RFID tag detection and reading. Thus, for a given application there is for practical reasons a lower limit on the distance between the ground plane and the radiating element in a traditional patch antenna design, and this constrains the overall thickness of the antenna.

Another constraint on the thickness of a traditional patch antenna stems from radiation efficiency (fraction of total electrical energy put into the antenna which is emitted as electromagnetic radiation). If the lossy dielectric thickness or gap between the reference ground and radiating element is too small, the radiating efficiency will be too low because too much of the energy to the antenna is wasted as heat flowing into the dielectric and surroundings.

The EAS system uses large conductive loops to create a strong magnetic field. When a large piece of conductor is exposed to this magnetic field, the induced eddy currents create induced magnetic fields that oppose the change of the original magnetic field, i.e., the original magnetic field is degraded. The eddy current generally increases with the increased conductive area. Thus, the conventional RFID antenna may interfere with operation of the EAS antenna.

It is therefore desirable to have an RFID antenna that is relatively inexpensive to manufacture, is easily integrated into existing pedestals, has a broad frequency band of performance, is relatively simple to feed, and has minimal interference with operation of an EAS antenna collocated in the same security system pedestal.

### SUMMARY OF THE INVENTION

The present invention advantageously provides an RFID antenna. According to one aspect, the RFID antenna has a first ground plane and a reference ground plane substantially parallel to the first ground plane. A first patch antenna element is coplanar with the reference ground plane. A second patch antenna element is coplanar with the first patch antenna element and is electrically coupled to the first patch antenna element.

According to another aspect, the invention provides an antenna system. The antenna system includes an array of RFID antennas. The RFID antenna array includes a plurality of first coplanar ground planes connected by at least one conductor that is coplanar with the first coplanar ground planes. The array also includes a plurality of coplanar patch antenna structures in which each coplanar patch antenna structure includes a reference ground plane substantially parallel to, and spaced apart from, at least one of the first coplanar ground planes. Each coplanar patch antenna structure also includes first and second patch antenna elements that are coplanar with the reference ground plane. The first and second patch antenna elements are electrically coupled. In one embodiment, the antenna system includes an EAS antenna that is at least partially disposed about a periphery of the RFID antenna array.

According to another aspect, the invention provides an RFID antenna in which a substrate has a first side and a second side opposite the first side. A ground plane is disposed on the first side of the substrate. A reference ground plane disposed on the second side of the substrate. A first patch antenna element disposed on the second side of the substrate. A second patch antenna element disposed on the second side of the substrate. The second patch antenna is coplanar with the first patch antenna element and the reference ground plane. The first patch antenna element and the second patch antenna element cooperate to provide a wide band frequency response that is wider than a frequency response of either one of the first and second patch antenna elements operating alone.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a patch antenna design typical of the prior art;

FIG. 2 is a diagram of a patch antenna in which a secondary radiating antenna element is placed adjacent to and connected to the primary radiating antenna element, constructed in accordance with principles of the present invention;

FIG. 3 is a diagram of a patch antenna with a coplanar reference ground and coplanar secondary radiating antenna element with high-aspect-ratio rectangular shape, constructed in accordance with principles of the present invention;

FIG. 4 is a diagram of a patch antenna with a coplanar reference ground and two coplanar secondary radiating antenna elements with high-aspect-ratio rectangular shape, constructed in accordance with principles of the present invention;

FIGS. 5-11 shows examples of alternative radiating antenna element shapes that may be employed in the patch antennas of FIGS. 2-4;

FIG. 12 is a graph showing the relationship between the regular patch antenna gain and the ground size, which is compared with patch size;

FIG. 13 is a graph showing the relationship between the magnetic field intensity and the shielding metal ground size, which is compared with the loop size;

FIG. 14 is a diagram of an individual antenna having an ESD protection short;

FIG. 15 is a diagram of an exemplary antenna array for a dual RFID-EAS pedestal with coplanar feeding transmission line; and

FIG. 16 is a diagram of an exemplary floating ground layout for the antenna array in FIG. 15.

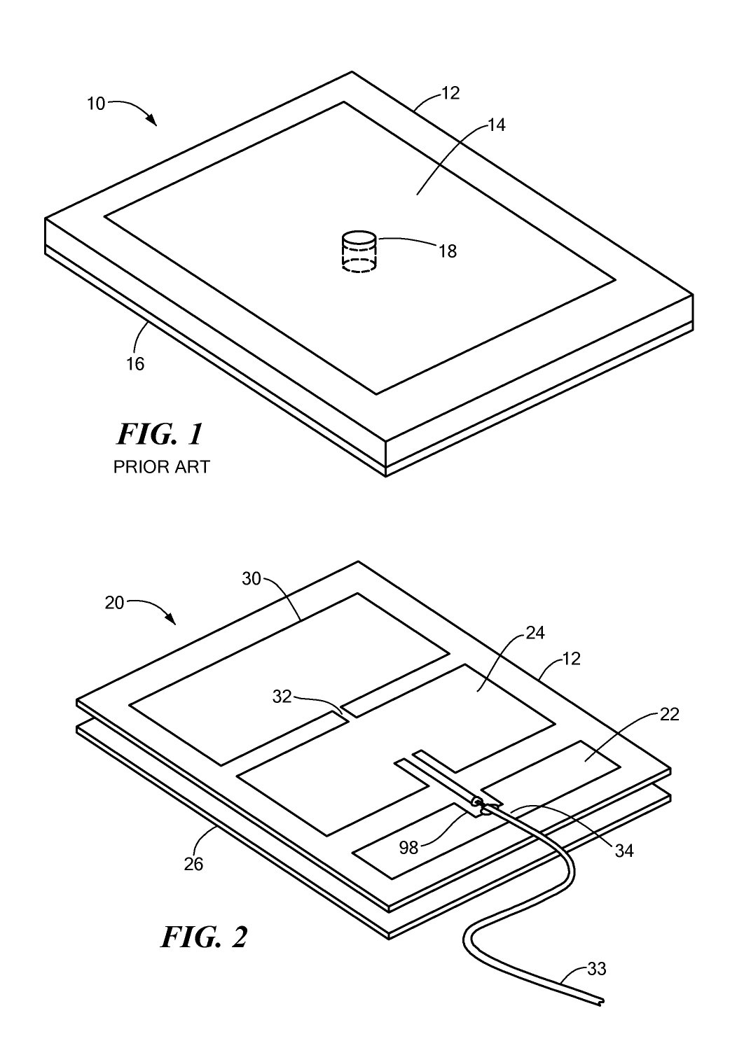

### DETAILED DESCRIPTION OF THE INVENTION

Before describing in detail exemplary embodiments that are in accordance with the present invention, it is noted that the embodiments reside primarily in combinations of apparatus components and processing steps related to implementing an antenna array for use in a combination RFID-EAS antenna system. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Referring now to the drawing figures, in which like reference designators denote like elements, there is shown in FIG. 2 a drawing illustrating an exemplary patch antenna assembly in accordance with the principles of the present invention and designated generally as “20”. In this embodiment, a patch antenna assembly 20 includes a first supporting dielectric substrate 12 like that commonly used in printed circuit boards that supports the radiating antenna element 24 and reference ground element 22. The radiating antenna element may be copper or some other conductive metal or ink printed, etched, or otherwise fabricated on a thin plastic sheet (e.g., copper on Mylar), which plastic sheet (not shown in FIG. 2) is itself placed on top of a suitable dielectric material 12 such as a foamed plastic of a specific design thickness (e.g., 2 or 3 mm). In FIG. 2, a floating ground 26 can be a solid metal sheet, metal foil laminated to the top or bottom surface of a dielectric material, or laminated to some other convenient carrier surface (not shown in the FIG. 2) above or below the dielectric layer 12. Alternatively, the floating ground 130 can be a printed or etched conductor on the underside of the same circuit board or other dielectric material layer 12 which is supporting the radiating antenna element 24 and the reference ground element 22.

In some embodiments, there is an air-filled space or gap between the dielectric material supporting the floating ground 26 and the dielectric material supporting the radiating antenna element 24 and reference ground element 22. The size of the air space or gap is maintained in the preferred embodiment by a non-conductive support which holds the edges of the two printed circuit boards at a fixed distance of separation. In another embodiment, the elements 24, 22, and 26 are all fabricated on two sides of a single dielectric material, such as a foamed plastic.

The antenna patch 24, reference ground 22 and floating ground 26 may be solid copper metal plating, but it should be immediately clear to those skilled in the art that other types of electrically conductive materials may be used for these elements of the antenna assembly.

Signals are fed to the antenna at point 28 where, in one embodiment, a coaxial cable 33 has been attached with the cable's core conductor soldered to the radiating antenna element at 28 and the cable shielding mesh 34 soldered to the reference ground element 22, as shown. In one embodiment the total separation between the antenna patch 24 and the floating ground 26 is between 2 and 3 mm, but larger or smaller separations can also be used. Easy feeding is an advantage of this configuration since the radiating antenna element 24 and the reference ground element 22 are in the same plane and situated close to each other.

A secondary radiating antenna element 30 is physically connected to the primary radiating antenna element 24 via the conductive trace 32. In one embodiment the secondary radiating antenna element 30 is placed adjacent to and coplanar with the primary radiating element 24. In other embodiments the secondary element 30 may be placed in one or more closely spaced substantially parallel planes, with little or no overlap between the primary and secondary radiating elements. It should be recognized that in alternative embodiments, the trace 32 may not necessarily be connected to the edges of radiating elements. The connection can be inside of the radiating elements, and its location may vary.

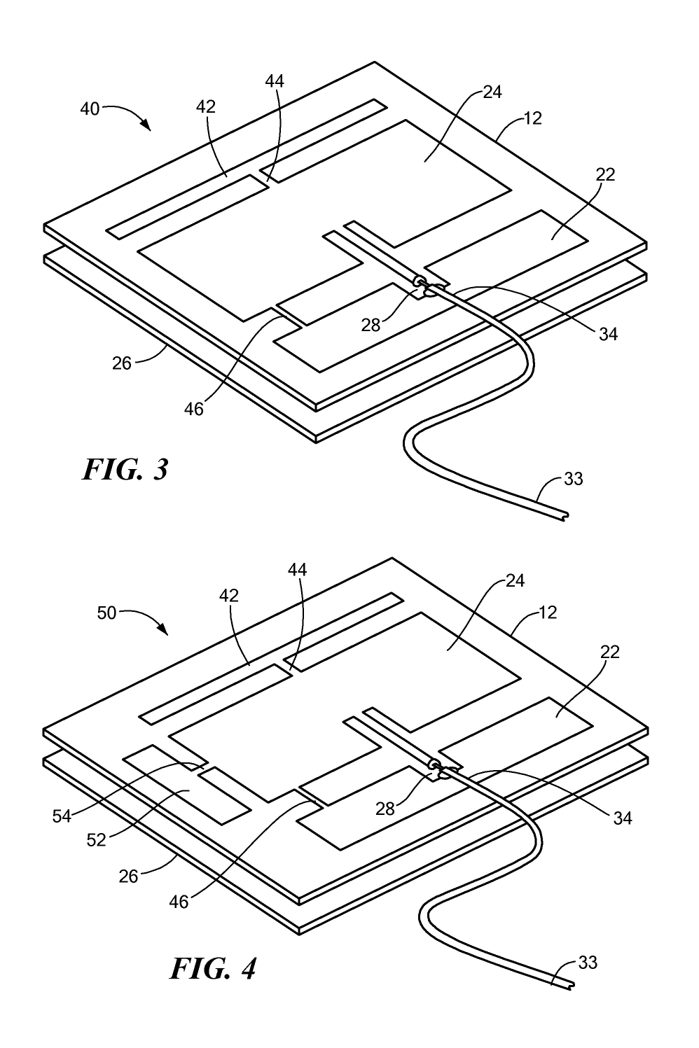

The secondary antenna element can be put on any one of the three open sides of the primary antenna element. FIG. 2 shows one of these locations. The shape and proportions of the secondary radiating element may be similar to the primary radiating element (as shown in FIG. 2), or it may have different shape or proportion, as shown in FIG. 3 in which secondary radiating antenna element 42 has been connected to primary radiating antenna element 24 via trace 44. An advantage of the secondary radiating antenna element with this high aspect ratio (length/width) is that the arrangement allows a more compact antenna design, although the radiation bandwidth is somewhat reduced, relative to the design of FIG. 2.

FIG. 3 also illustrates a DC electrostatic dissipation (ESD) short connection 46 between the primary radiating antenna element 24 and the reference ground element 22. This DC short connection greatly reduces the chance that a static charge can build up between the primary antenna element 24 and the reference ground element 22. Such static charge buildup can result in electrostatic dissipation (ESD) damage to circuit components. DC ESD short connection 46 can prevent such damage.

In other embodiments of the invention, additional secondary radiating antenna elements can be added to further increase the radiation bandwidth. FIG. 4 shows two secondary radiating antenna elements 42 and 52 connected to the primary radiating antenna element 24 via traces 44 and 54, respectively. It should be recognized that other embodiments exist in which additional secondary antenna elements are added. FIG. 4 is provided by way of example only and is not intended to limit the scope and application of the current invention. The dimensions and placement of the secondary radiating elements 42 and 52 may affect a bandwidth of the antenna structure 50. For instance, the radiating element 42 may exhibit a resonance in addition to a resonance exhibited by the primary radiating element 24. Further, the radiating element 52, may exhibit another reference, such that three distinct resonances may be observed. The positions of these resonances may be adjusted to broaden the bandwidth of the antenna structure 50.

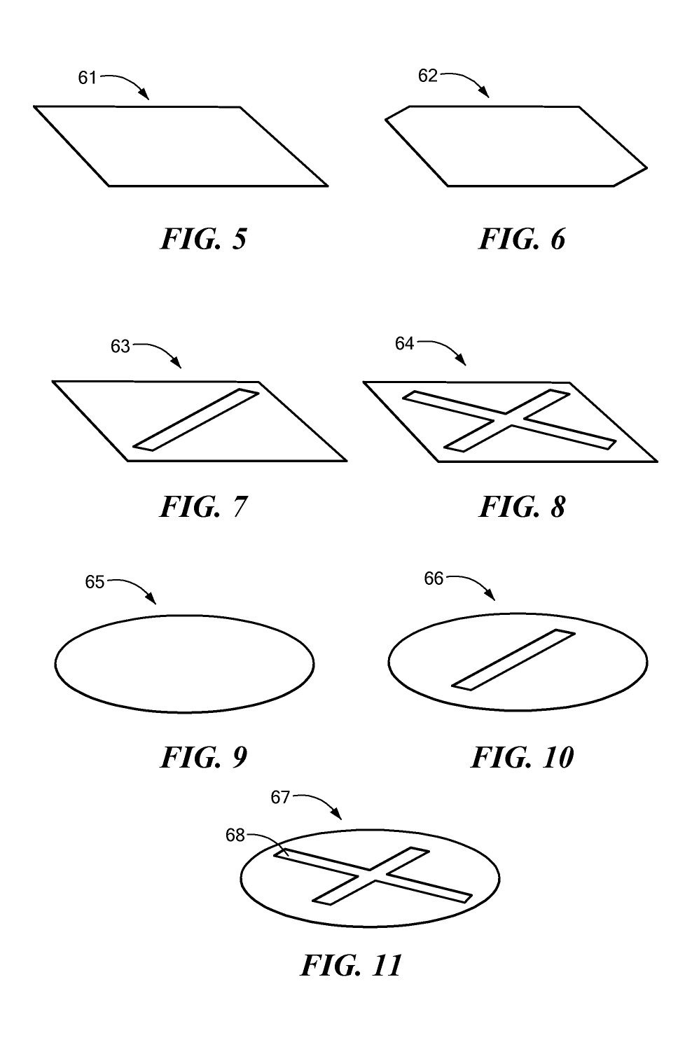

The primary and secondary radiating antenna elements of the invention may be implemented in any pattern or geometrical shape (e.g., square, rectangular, circle, free flow, etc.). Several of these shape alternatives are shown in FIGS. 5-11, including a rectangular shape 61 (FIG. 5), rectangular shape with trimmed, i.e., chamfered, corners along one diagonal 62 (FIG. 6), rectangular shape 63 with a slot (FIG. 7), rectangular shape with two orthogonal slots 64 (FIG. 8), circular shape 65 (FIG. 9), circular shape 66 with a slot (FIG. 10), and circular shape 67 with two orthogonal slots 68 (FIG. 11). These alternatives are shown by way of example only and are not intended to limit the scope and application of the current invention. Trimmed or angled corners, such as those used with antenna shape 62, and slots such as those used in antenna shapes 63, 64, 66, and 67 of FIGS. 5-11 lead to a circularly polarized field around the antenna and improve tag readability. Slots also reduce interference via eddy currents with operation of an EAS antenna in proximity to the RFID antenna. An example of such slots is shown in FIG. 11 as slots 68.

The shapes of the primary and secondary radiating antenna elements and reference ground element, the relative locations among the primary and secondary radiating antenna elements and reference ground element, the locations and widths of conductive traces, the feed location for the primary radiating antenna element and the reference ground element, the size and placement of slots, slits, or other voids in the primary and secondary radiating antenna elements and/or reference ground element, as well as the presence or absence of the floating ground element, its size and shape, the dielectric material and its thickness between the radiating antenna elements and the floating ground element, and the location of or presence of an electrical connection or “short” between the primary radiating antenna element and floating ground, may each individually or together be adjusted to optimize the antenna radiation bandwidth, radiation gain, radiation pattern, radiation efficiency, and antenna polarization. Also, the above characteristics of the antenna and its various components, particularly the characteristics of antenna element shapes, slots, slits, and cut, i.e., chamfered, corners, can be adjusted to reach the desired antenna size.

For example, the details of the slits or slots, and nature of the chamfered corners, also have a significant effect on the frequency response of the antenna, and can be used to increase the bandwidth of the antenna. It is observed that the addition of one secondary square radiating element with diagonal corner cuts contributes two inherent resonant frequencies to the antenna characteristics. As a result, the introduction of secondary radiating elements extends the radiation bandwidth.

The primary and secondary radiating antenna elements of the current invention may be made up of a metal plate, metal foil, printed or sprayed electrically conductive ink or paint, conductive polymer material, metal wire mesh, or other functionally equivalent material (e.g., film, plate, metal flake, etc.), or any other homogeneous or composite material of adequate conductivity. The material of antenna substrate 100 is a dielectric material (e.g., the material typically used for printed circuit boards) or any other material having negligible electrical conductivity. The substrate 100 may include a combination of two or more different types of such negligibly conductive material, as may be used in a laminated or layered structure.

The transmission line, shown as cable 33, may have at either end, or located along its length, tuning components (not shown) such as capacitors and inductors. The sizes (e.g., capacitance or inductance) of these tuning components are chosen based on the desired matching and bandwidth characteristics of the antenna, according to practices well known to those skilled in the art.

Addition of one or more secondary radiating antenna elements according to the invention allows one to use a thinner substrate without sacrificing antenna bandwidth. Another advantage of the secondary radiating elements is gain enhancement because of the combination effect of radiated electromagnetic fields from antenna elements. The floating ground plane plays a role in the performance of the dual RFID-EAS system. It affects the performance of both the RFID antenna and the EAS loop.

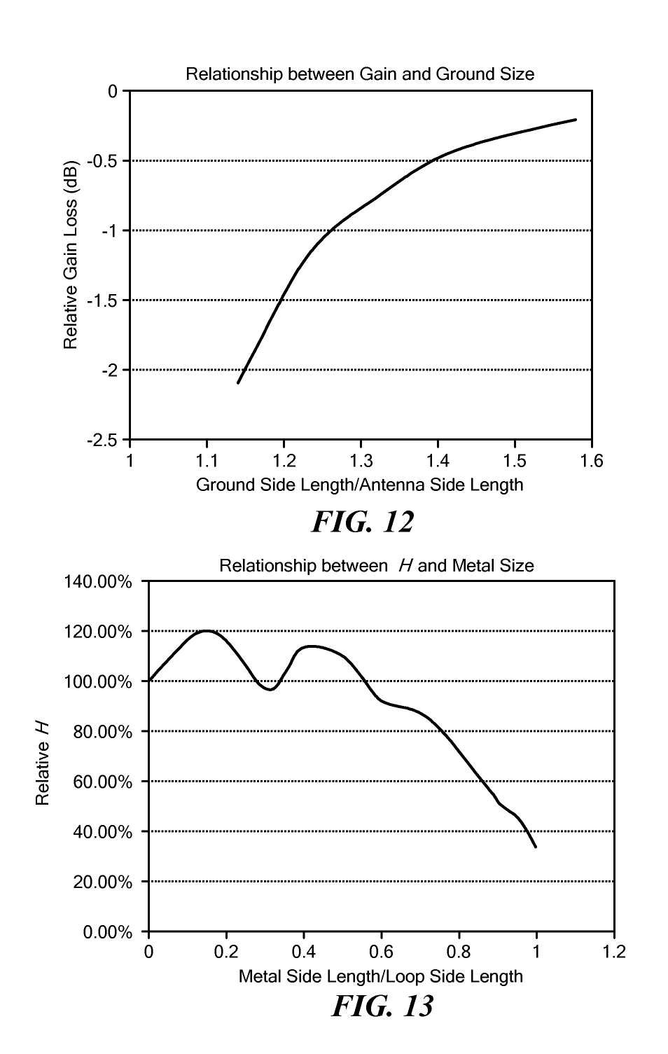

FIG. 12 is a graph showing the relationship between the patch antenna gain and the antenna ground size, where both the antenna and the ground are substantially square. As the ground size decreases, the antenna gain decreases. The decrease accelerates dramatically when the ground size is smaller than 1.25 times the antenna size.

FIG. 13 is a graph showing the relationship between the magnetic field intensity and the metal shielding size, where both the loop and metal are substantially square. As is seen in FIG. 13, decreasing metal size improves the magnetic field intensity. When the metal size is less than half of the loop size, the magnetic field is no longer affected significantly by the metal.

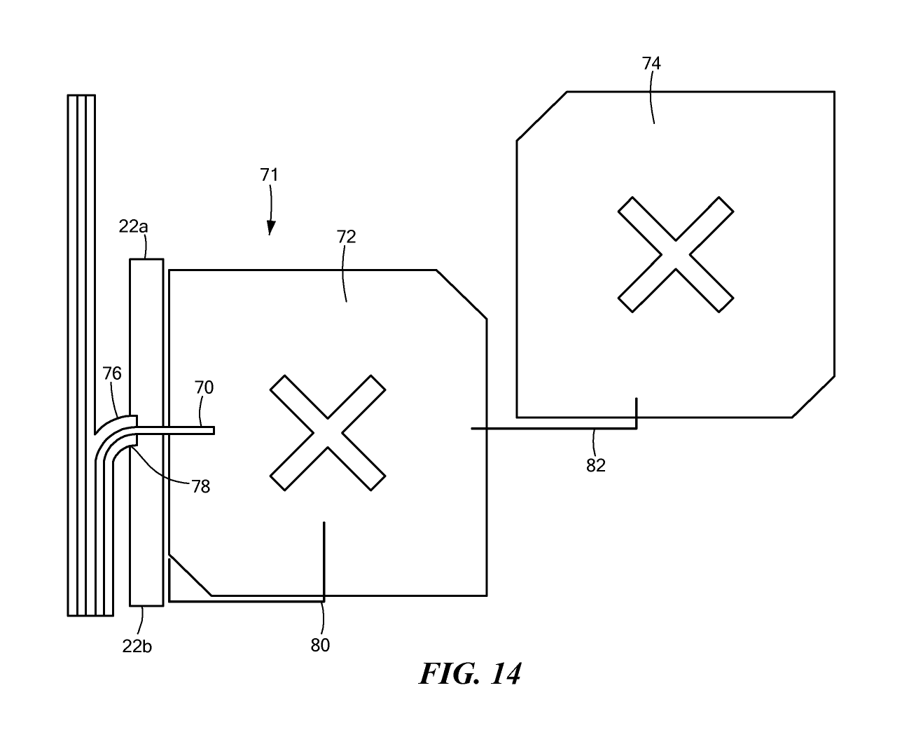

FIG. 14 shows a detailed drawing of an antenna unit 71. The antenna unit 71 has two radiating elements, 72 and 74, which are connected by the conductive trace 82. The reference ground plane has a portion 22a and a portion 22b, which are adjacent and coplanar with the primary radiating element 72. In one particular design, patch elements 72 and 74 are both 5.2 inches (13 cm) square. The antenna unit 71 is fed with a novel coplanar transmission line, which includes signal trace 70 and ground traces 76 and 78. The feeding transmission lines 76 and 78 share a common ground. The reference ground plane 22 and ground trace are reduced with respect to the size of elements 72 and 42 in order to improve the EAS system performance and remove dead zones directly in front of the antenna.

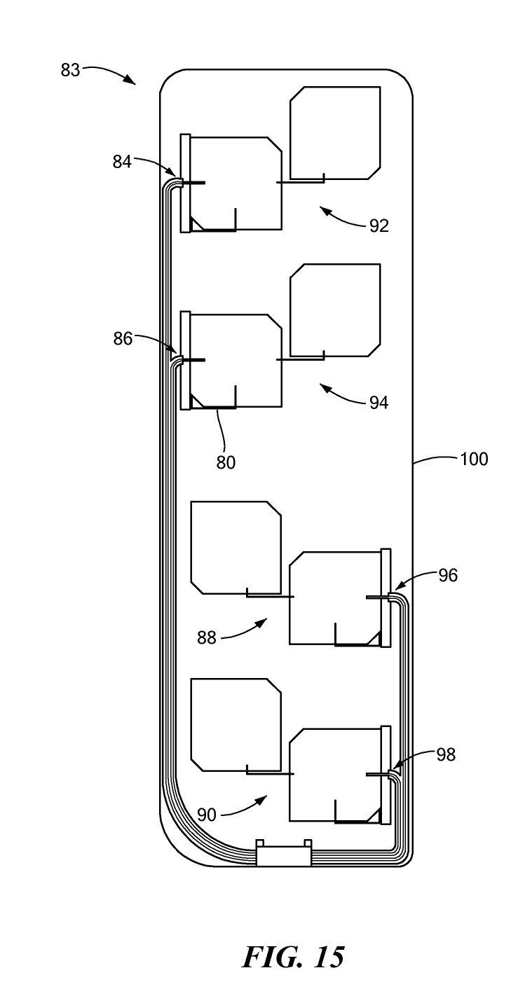

FIG. 15 shows an exemplary combination RFID antenna array and EAS loop antenna 83. The RFID antenna array includes four antenna units 88, 90, 92, and 94, and corresponding transmission lines 84, 86, 96 and 98. An exemplary outline dimension of this antenna array is substantially 48 in (122 cm) long and 15 in (38 cm) wide. An EAS loop antenna 100 is at least partially disposed about the RFID antenna array in this embodiment and is coupled to an EAS control circuit (not shown) for providing EAS functionality. In other words, with respect to the RFID antenna array, EAS loop antenna 100 can partially or totally circumscribe some or all of the components of the RFID antenna array. Of note, although the embodiment of FIG. 15 shows four antenna units, it is understood that the invention is not limited to such. More or fewer antenna units can be used depending on the desired coverage, size available, etc.

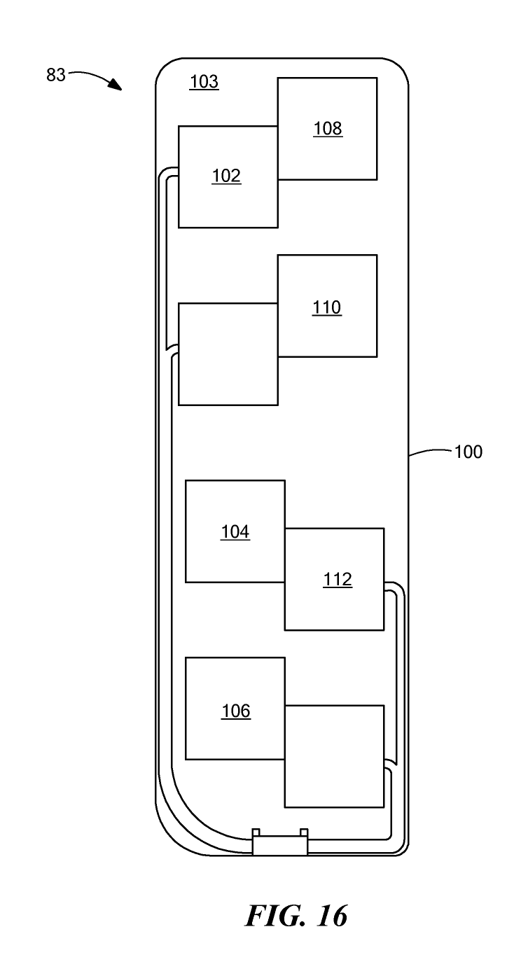

FIG. 16 shows the floating ground plane 104, 106, 108, and 110 used for the antenna array shown in FIG. 14. In one embodiment, each transmission line has a corresponding ground plane 102, 112 with a similar size. In one embodiment, a floating ground plane size is about 1 inch (2.5 cm) larger than the patch size, which is about 5.2 inches (13 cm) square. Such a configuration provides one side radiation of RFID antenna without harming the performance of EAS antenna 100.

A gain reduction can be observed with a reduced floating ground plane. In certain cases, it is desirable to reduce the gain in order to reach a better EAS system performance. In order to improve the RFID radiation gain, a layer of shielding ground with very low conductivity can be attached to the floating ground plane, such as the metalized Mylar material with a very thin layer (for example, 3 μm) of aluminum. Because aluminum's skin depth is about 2.7 μm at 0.9 GHz and 115 μm at 0.5 MHz, the metalized material can let the magnetic field at the AM band penetrate easily (only 0.2 dB attenuation), while maintaining reasonable shielding in the UHF band (about 10 dB attenuation). Thus, in some embodiments, the ground plane may be made of an ultra-thin conductive material arranged to permit the passage of low frequency, e.g., 58 kHz, signals, through the ground plane while blocking ultra-high frequency (UHF) signals. Further, in some embodiments a secondary ground plane 103 may be positioned below the floating ground planes 104, 106, 108 and 110, e.g., parallel to the floating ground planes 104, 106, 108 and 110, where the secondary ground plane 103 is made of an ultra-thin conductive material arranged to permit the passage of low frequency signals through the secondary ground plane while blocking ultra-high frequency (UHF) signals.

It should also be noted that various arrays of antenna assemblies may be constructed in which the antenna assemblies occupy two different planes. For example, one may build an array of antenna assemblies in which some of the assemblies are located inside a first geometric plane, and the remainder of the assemblies is located inside a second geometric plane orthogonal to the first geometric plane. This embodiment is given by way of example only, and it should be noted that the two planes need not necessarily be orthogonal. Also, it is conceivable that more than two geometric planes may be used in the placement of the antenna assemblies. Such a multi-planar array of antenna assemblies may improve the robustness of the array in some applications in which, for instance, the orientation of the RFID tags to be interrogated by the antennas is not known, or is known to be random or varying. In addition, the application may demand specific electrical or magnetic field polarization which may be produced by placement of the antenna assemblies in several planes.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An RFID antenna, comprising:
a first ground plane;
a reference ground plane substantially parallel to the first ground plane;
a first patch antenna element coplanar with the reference ground plane; and
a second patch antenna element coplanar with the reference ground plane and electrically coupled to the first patch antenna element.

2. The RFID antenna of claim 1, further comprising an electrostatic discharge connection between the reference ground plane and the first patch antenna element.

3. The RFID antenna of claim 1, wherein the first patch antenna element has a first width and a first length, the second patch antenna element has a second width and a second length, and a ratio of the second length to the second width is greater than a ratio of the first length to the first width.

4. The RFID antenna of claim 3, wherein the ratios of the first patch antenna and the second patch antenna are adjusted to create a dual resonance exhibited by the RFID antenna.

5. The RFID antenna of claim 1, further comprising a third patch antenna element electrically coupled to the first patch antenna element.

6. The RFID antenna element of claim 5, wherein the third patch antenna element has a length that is oriented substantially at a right angle to a length of the second patch antenna element.

7. The RFID antenna of claim 6, wherein a length-to-width ratio of the second patch antenna element is adjusted to create a secondary resonance and a length-to-width ratio of the third patch antenna element is adjusted to create a tertiary resonance exhibited by the RFID antenna.

8. The RFID antenna element of claim 1, further comprising a coaxial cable having an inner conductor and an outer conductor, the inner conductor electrically coupled to the first patch antenna element and the outer conductor electrically coupled to the reference ground plane.

9. The RFID antenna of claim 1, wherein the first antenna patch element has a slot to reduce interference with operation of an EAS antenna in proximity to the RFID antenna.

10. The RFID antenna of claim 1, wherein the first antenna patch element is substantially rectangular other than having at least one chamfered corner.

11. An antenna system, comprising:
a radio frequency identification (RFID) antenna array, having:
a plurality of first coplanar ground planes connected by at least one conductor that is coplanar with the first coplanar ground planes; and
a plurality of coplanar patch antenna structures, each coplanar patch antenna structure having:
a reference ground plane substantially parallel to, and spaced apart from, at least one of the first coplanar ground planes;
a first patch antenna element coplanar with the reference ground plane; and
a second patch antenna element coplanar with the reference ground plane and electrically coupled to the first patch antenna element.

12. The antenna system of claim 11, further comprising an EAS antenna, the EAS antenna being at least partially disposed about a periphery of the RFID antenna array.

13. The antenna system of claim 11, wherein the RFID antenna array further comprises a plurality of signal-bearing conductors coplanar with a reference ground plane, each conductor electrically coupled to the first patch antenna element of a corresponding one of each of the plurality of patch antenna structures.

14. The antenna system of claim 13, wherein the RFID antenna array further comprises a plurality of ground conductors coplanar with a reference ground plane, each of the plurality of ground conductors electrically coupled to a corresponding one of each of the reference ground planes.

15. The antenna system of claim 11, wherein a gain of a patch antenna structure is adjusted by adjusting a ratio of a dimension of the reference ground plane to a dimension of the first patch antenna element.

16. The antenna system of claim 11, wherein the plurality of coplanar patch antenna structures are arranged such that electromagnetic fields of the individual coplanar patch antenna structures overlap.

17. An RFID antenna, comprising:
a substrate having a first side and a second side opposite the first side;
a ground plane disposed on the first side of the substrate;
a reference ground plane disposed on the second side of the substrate:
a first patch antenna element disposed on the second side of the substrate; and
a second patch antenna element disposed on the second side of the substrate, the second patch antenna being coplanar with the first patch antenna element and the reference ground plane;
the first patch antenna element and the second patch antenna element cooperating to provide a wide band frequency response that is wider than a frequency response of either one of the first and second patch antenna elements operating alone.

18. The RFID antenna of claim 17, wherein the ground plane is comprised of a conductive material having a thickness adapted to allow passage of low frequency wave signals through the ground plane while blocking ultra-high frequency (UHF) signals.

19. The RFID antenna of claim 17, further comprising a secondary ground plane, the secondary ground plane being positioned parallel to the ground plane, the secondary ground plane being comprised of a conductive material and having a thickness adapted to allow passage of low frequency signals through the ground plane while blocking ultra-high frequency (UHF) signals.

20. The RFID antenna of claim 17, wherein a breadth of the wide band frequency response is adjusted by selecting an aspect ratio of the second patch antenna element, the aspect ratio being a ratio of a length to width of the second patch antenna element.
